(19) United States
(12) Patent Application Publication
(10) Pub. No.: US 2026/0296063 A1
(43) Pub. Date: Oct. 1, 2026

(54) LIQUID DISCHARGE APPARATUS, LIGHT RADIATION APPARATUS, HEATING APPARATUS, AND IMAGE FORMING APPARATUS

(71) Applicant: Hajime ONUKI, Kanagawa (JP)

(72) Inventor: Hajime ONUKI, Kanagawa (JP)

(21) Appl. No.: 19/549,013

(22) Filed: Feb. 25, 2026

(30) Foreign Application Priority Data
Mar. 25, 2025 (JP) 2025-049823
Nov. 27, 2025 (JP) 2025-205576

(51) Int. Cl. B41J 11/00; B41J 2/21

(52) U.S. Cl. CPC B41J 11/00212; B41J 2/2114; B41J 11/00216; B41J 11/00218; B41J 11/0022; B41J 11/007

(57) ABSTRACT

A liquid discharge apparatus includes: a conveyor to convey a medium in a conveyance direction; a liquid discharger configured to discharge a liquid in a discharge direction orthogonal to the conveyance direction, onto a medium conveyed by the conveyor; and a heater configured to heat the medium onto which the liquid has been applied, and the heater includes: multiple near-infrared lamps to irradiate the medium with near-infrared rays; and an infrared wavelength converter to convert a wavelength of the near-infrared rays emitted from the multiple near-infrared lamps, and the infrared wavelength converter is: disposed between the multiple near-infrared lamps and the conveyor in the discharge direction; and separated from the conveyor in the discharge direction.

### CROSS-REFERENCE TO RELATED APPLICATIONS

This patent application is based on and claims priority pursuant to 35 U.S.C. § 119(a) to Japanese Patent Application No. 2025-049823, filed on Mar. 25, 2025, in the Japan Patent Office, and Japanese Patent Application No. 2025-205576, filed on Nov. 27, 2025, in the Japan Patent Office, the entire disclosure of which are hereby incorporated by reference herein.

### BACKGROUND

### Technical Field

The present disclosure relates to a liquid discharge apparatus, a light radiation apparatus, a heating apparatus, and an image forming apparatus.

### Related Art

A liquid discharge apparatus includes a liquid discharger that discharges liquid to a liquid discharge target, and a heater that heats the liquid discharge target. For example, there is an aqueous inkjet printer corresponding to the liquid discharge apparatus. This aqueous inkjet printer includes a halogen lamp serving as a heat source of an ink drying light source device, with the following structure.

This halogen lamp has a coating layer provided on a part of an outer wall of a luminous tube that is filled with halogen gas and houses a filament. The coating layer shifts a peak wavelength range of light emitted from the luminous tube to a long-wavelength side with respect to a peak wavelength range of light emitted from the filament. Light having a spectral distribution close to an absorption band of water (solvent) contained in aqueous ink can be emitted through the coating layer.

The heating apparatus has room for improvement when it is necessary to place multiple lamps as heat sources according to the size of a heating region. It is conceivable that the function of the coating layer may deteriorate due to, for example, rubbing of the coating layer on the lamp outer wall by a recording medium or the like to be dried, and parts may need to be replaced so as to continue heating by emission of light in a desired peak wavelength range. There is room for improvement in reduction of the cost and effort of this part replacement.

### SUMMARY

The present disclosure described herein provides a liquid discharge apparatus including: a conveyor to convey a medium in a conveyance direction; a liquid discharger configured to discharge a liquid in a discharge direction orthogonal to the conveyance direction, onto a medium conveyed by the conveyor; and a heater configured to heat the medium onto which the liquid has been applied, and the heater includes: multiple near-infrared lamps to irradiate the medium with near-infrared rays; and an infrared wavelength converter to convert a wavelength of the near-infrared rays emitted from the multiple near-infrared lamps, and the infrared wavelength converter is: disposed between the multiple near-infrared lamps and the conveyor in the discharge direction; and separated from the conveyor in the discharge direction.

The present disclosure described herein provides a light radiation apparatus including: multiple lamps to emit light; and a wavelength converter to convert a wavelength of the light emitted from each of the multiple lamps, wherein the wavelength converter is disposed: between the multiple lamps and a medium to be heated; and separated from the multiple lamps, and the wavelength converter converts the wavelength of the light emitted from at least two or more of the lamps.

The present disclosure described herein provides a light radiation apparatus including: a lamp to emit infrared ray; a wavelength converter to convert a wavelength of the infrared ray emitted from the lamp; and a substrate disposed between the lamp and a medium to be heated, wherein the wavelength converter is on a surface of the lamp, and the substrate transmits the infrared ray emitted from the lamp to the medium.

### BRIEF DESCRIPTIONS OF DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating a schematic structural outline of an image forming apparatus according to an embodiment of the present disclosure;

FIG. 2 is a diagram illustrating a schematic structural outline of an image forming apparatus according to a modification;

FIG. 3 is a schematic configuration diagram of a dryer;

FIG. 4 is a schematic configuration diagram of a dryer according to a first modification;

FIG. 5 is a schematic configuration diagram of a dryer according to a second modification;

FIG. 6 is a perspective view of an exemplary mechanism of a heater;

FIG. 7 is a schematic configuration diagram of a dryer according to a third modification;

FIG. 8 is a schematic diagram illustrating a separation mechanism;

FIG. 9 is a schematic diagram illustrating an exemplary case in which a second dryer is provided in the image forming apparatus of FIG. 1;

FIG. 10 is a diagram illustrating a schematic structural outline of an exemplary case in which the second dryer is provided in the image forming apparatus of FIG. 2;

FIG. 11 is a schematic configuration diagram illustrating an exemplary combination of the dryer and the second dryer;

FIG. 12 is a schematic configuration diagram illustrating a second exemplary combination of the dryer and the second dryer;

FIG. 13 is a schematic configuration diagram illustrating a third exemplary combination of the dryer and the second dryer;

FIG. 14 is a schematic configuration diagram illustrating a fourth exemplary combination of the dryer and the second dryer;

FIG. 15 is a schematic configuration diagram illustrating a fifth exemplary combination of the dryer and the second dryer; and

FIG. 16 is a schematic configuration diagram illustrating a sixth exemplary combination of the dryer and the second dryer.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION OF EMBODIMENTS

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

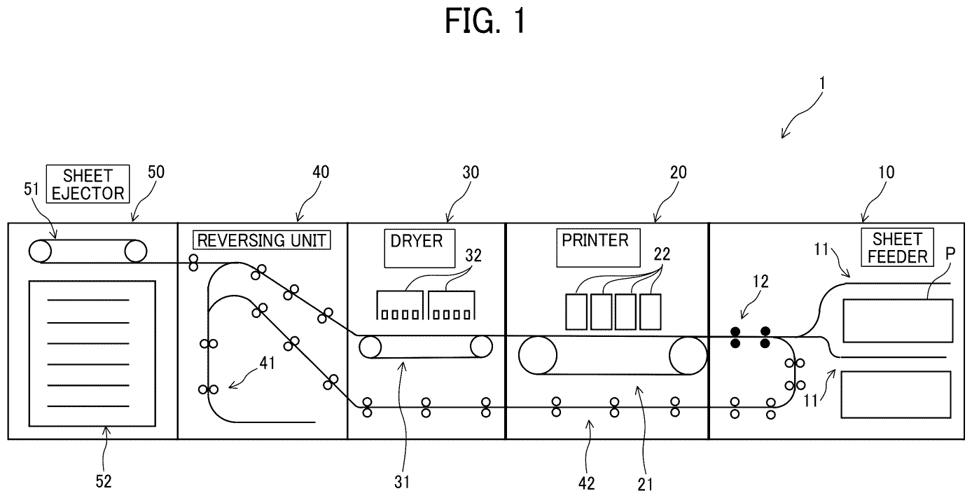

Hereinafter, a description will be given of an embodiment applied to a drying device of an image forming apparatus which corresponds to a liquid discharge apparatus using a liquid discharger for image formation. FIG. 1 is a diagram illustrating a schematic structural outline of an image forming apparatus 1. The image forming apparatus includes a sheet feeder 10, a printer 20, a dryer 30, a reversing unit 40, and a sheet ejector 50. In the image forming apparatus 1, the printer 20 applies liquid to a sheet P fed from the sheet feeder 10 to perform desired printing, and the dryer 30 dries the liquid having adhered to the sheet P. Then, the sheet P is ejected to the sheet ejector 50 via the reversing unit 40. The sheet P is, for example, a paper sheet, and corresponds to a recording medium or a liquid discharge target.

The sheet feeder 10 has a function of conveying stacked sheets P one by one toward the printer 20. The sheet feeder 10 includes a sheet loading and feeding devices 11, registration rollers 12, and the like. The printer 20 has a function of forming an image by discharging ink toward a recording medium conveyed from the sheet feeder 10 or the reversing unit 40 to be described below, and a function of conveying the sheet P on which an image has been formed to the dryer 30. The printer 20 is referred to also as “an image former”.

The printer 20 includes a sheet conveyor 21, discharge units 22, and the like. The discharge units 22 each serve as a liquid discharger that discharges aqueous ink, which is liquid, toward the sheet P. While the sheet P is being moved in a conveyance direction by the sheet conveyor 21, an image is formed by aqueous ink discharged from an inkjet recording head of each discharge unit 22. The discharge units 22 are referred to also as “liquid dischargers”.

The discharge unit 22 is provided for each of at least two or more colors such as cyan, magenta, yellow, and black. Liquids of at least two or more colors are discharged from the discharge units 22, and thus, an image corresponding to print information is printed. The discharge units 22 each correspond to an image former.

The dryer 30 has a function of drying the sheet P conveyed from the printer 20 and a function of conveying the dried sheet P to the reversing unit 40. The dryer 30 includes a sheet conveyor 31, heaters 32 serving as heating apparatuses, and the like, and functions as a drying device. The dryer 30 will be described in detail below.

The reversing unit 40 has a function of reversing a first surface (printing surface) and a second surface of the sheet P conveyed from the dryer 30 and conveying the sheet P to the printer, or a function of conveying, to the sheet ejector 50, the sheet P conveyed from the dryer 30. The reversing unit 40 includes pairs of conveying rollers and a reversing path 41 for reversal.

The reversing unit 40 reverses the first surface and the second surface of the sheet P by using the reversing path 41 only at the time of duplex printing, and sends the sheet P to a re-feeding path 42 for conveyance to the printer 20 via the registration rollers 12.

The sheet ejector 50 has a function of stacking sheets P conveyed from the reversing unit 40. The sheet ejector 50 includes an attraction conveyance belt 51, a stack unit 52, and the like.

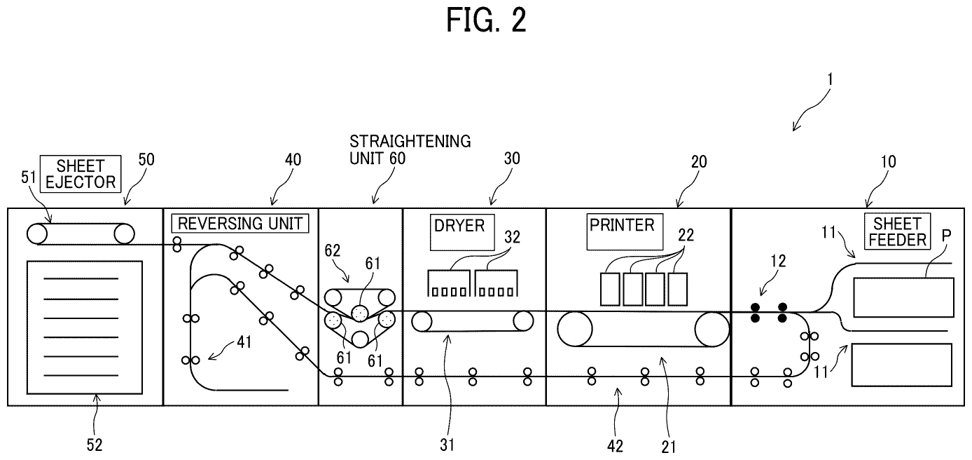

As illustrated in FIG. 2, the image forming apparatus 1 may include a straightening unit 60 between the dryer 30 and the sheet ejector 50, for example, between the dryer 30 and the reversing unit 40. The straightening unit 60 serves as a posttreatment unit that performs posttreatment on the sheet P to which liquid has adhered. The straightening unit 60 has a function of straightening the sheet P conveyed from the dryer 30 and a function of conveying the straightened sheet P to the reversing unit. The straightening unit 60 includes, for example, a belt device 62 that heats the sheet P while winding the sheet P around heat rollers 61.

When the straightening unit 60 is provided between the dryer 30 and the reversing unit 40, the dryer 30 conveys the dried sheet P to the straightening unit 60. The reversing unit has a function of reversing the sheet P conveyed from the straightening unit 60 and conveying the sheet P to the printer 20 or a function of conveying, to the sheet ejector 50, the sheet P conveyed from the straightening unit 60.

Furthermore, in the image forming apparatus 1, a pretreatment unit that performs pretreatment on the sheet P may be disposed on the upstream side of the printer 20. For example, the pretreatment device may perform a pretreatment process of applying treatment liquid onto the sheet P before an image is printed on the sheet P. The treatment liquid reacts with liquid to reduce bleeding of the liquid on the sheet P. However, the content of the pretreatment process is not particularly limited to the process as described above.

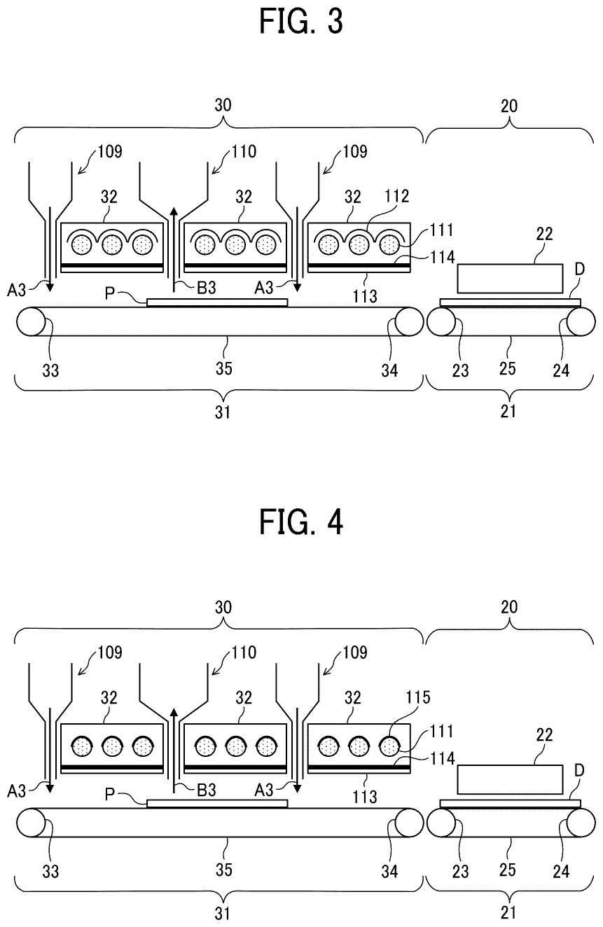

FIG. 3 is a schematic configuration diagram of the dryer 30. The sheet conveyor 31 includes a driving roller 33, a driven roller 34, and a conveying belt 35. The driving roller 33 is a motor-driven roller. The driven roller 34 is driven to rotate. The conveying belt 35 is driven by these rollers. The sheet conveyor 21 of the printer 20 illustrated in FIG. 3 also includes a driving roller 23, a driven roller 24, and a conveying belt 25.

The dryer 30 includes multiple infrared heaters as the heaters 32. The heaters 32 heat the sheet P being moved by the sheet conveyor 31, and dry ink on the sheet P. The heaters 32 each include multiple near-infrared lamps 111 and a reflecting plate 112, and also include a glass plate 113 as a substrate between the near-infrared lamps 111 and the sheet P.

A near-infrared lamp including a single filament in a straight tube (such as a glass tube or a quartz tube) is defined as a single near-infrared lamp 111. An infrared conversion layer 114 is provided on a surface of the glass plate 113 facing the near-infrared lamps 111. The infrared conversion layer 114 shifts a peak wavelength range of light emitted from each near-infrared lamp 111 to a long-wavelength side with respect to a peak wavelength range of light emitted from the filament. The infrared conversion layer 114 is irradiated with near-infrared rays emitted from the near-infrared lamps 111 directly or via the reflecting plate 112, and generates heat. Thus, the infrared conversion layer 114 emits far-infrared rays toward the sheet P.

Liquid on the sheet P is subjected to drying treatment by the far-infrared rays. Specifically, a liquid component such as water in the liquid evaporates. Thus, colorant contained in the liquid is fixed on the sheet P, and curling of the sheet P is reduced.

The dryer 30 also includes a supply air blower 109 and an exhaust 110 as vapor discharger that remove vapor generated from ink. The supply air blower 109 and the exhaust 110 are alternately disposed between the heaters 32. The supply air blower 109 takes in outside air by an air supply fan, and blows the outside air to the sheet P as indicated by arrows A3. The exhaust 110 discharges air containing vapor generated at the time of drying ink from the dryer 30, as indicated by arrow B3, by means of an exhaust fan to reduce humidity and saturated vapor pressure in the vicinity of the sheet P and promote the drying of the ink.

FIG. 4 is a schematic configuration diagram of a dryer 30 according to a first modification. Instead of the reflecting plate 112 in the dryer 30 of FIG. 3, an infrared reflecting layer 115 is provided on the near-infrared lamp 111. Specifically, the infrared reflecting layer 115 (such as a white coating) is provided on the upper half (the half on a side opposite to the sheet P) of a tube surface of the near-infrared lamp 111. Near-infrared rays emitted from the near-infrared lamp 111 are reflected by the infrared reflecting layer 115. Thus, the infrared reflecting layer 115 has an effect similar to the effect of the reflecting plate 112 in FIG. 3.

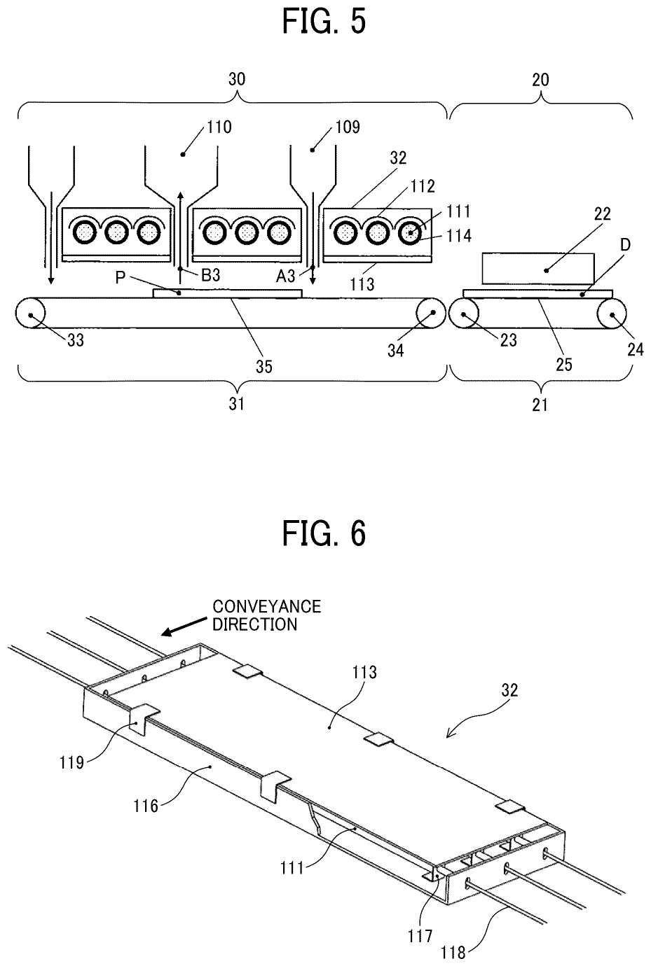

FIG. 5 is a schematic configuration diagram of a dryer 30 according to a second modification. The infrared conversion layer 114 in the dryer 30 of FIG. 3 has been provided on the tube surface of the near-infrared lamp 111. As a result, near-infrared rays emitted from the near-infrared lamp 111 are converted by the infrared conversion layer 114 on the tube surface into far-infrared rays and emitted as the far-infrared rays toward the sheet P, or reflected by the reflecting plate 112 and emitted toward the sheet P. Thus, the configuration of FIG. 5 has an effect similar to the effect of the configuration of FIG. 3.

FIG. 6 is a perspective view of an exemplary mechanism of the heater 32. The heater 32 includes multiple near-infrared lamps 111 in a unit support 116 serving as a support. The near-infrared lamps 111 are supported by the unit support 116 via a near-infrared lamp support 117. Both ends of the near-infrared lamp 111 have a lead wire 118. Thus, the near-infrared lamps 111 are electrically connected via the lead wires 118.

The glass plate 113 is supported by the unit support 116 via glass plate supports 119. Except for portions of the glass plate 113 which are engaged with the glass plate supports 119, the glass plate 113 is separated from the unit support 116. The glass plate 113 is separated from the unit support 116 in this manner. In addition, the glass plate supports 119 are each formed as a small piece member. As a result, the glass plate 113 is substantially thermally insulated from the unit support 116. It is considered that when the glass plate support 119 absorbs heat, the thermal insulation of the glass plate 113 prevents the glass plate support 119 from conducting heat away from the infrared conversion layer that has generated heat by absorption of near-infrared rays and causing a change in the radiation wavelength and radiation intensity of far-infrared rays. Therefore, when the glass plate support 119 absorbs heat, the glass plate 113 is considered to be substantially thermally insulated.

The infrared conversion layer 114 is provided on a surface of the glass plate 113 facing the near-infrared lamp 111. The length of the glass plate 13 in the conveyance direction is about equal to the length of the unit support 116. The length of the glass plate 13 in a direction of the width of the sheet P is equal to or greater than the light emission length of the near-infrared lamp 111.

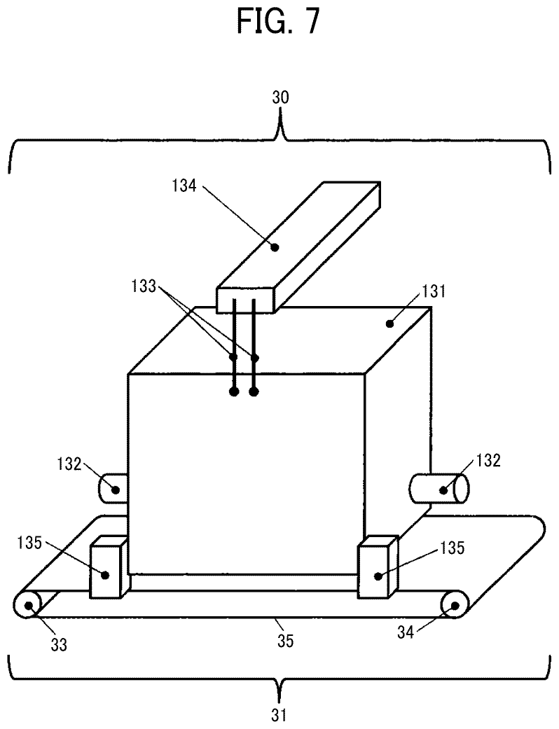

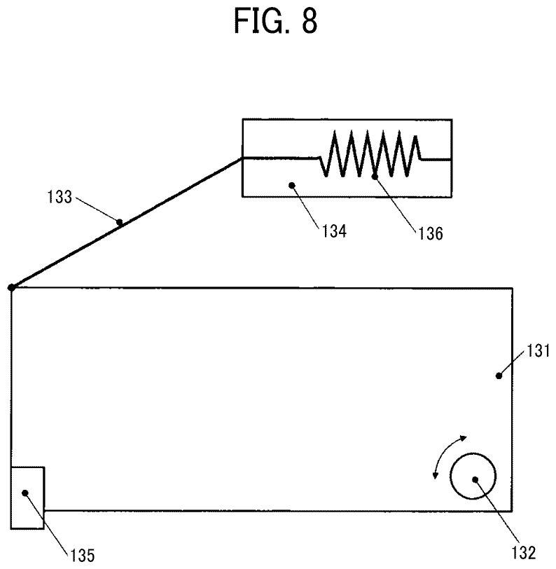

FIG. 7 is a schematic configuration diagram of a dryer 30 according to a third modification. FIG. 8 is a schematic diagram illustrating a separation mechanism as viewed from the side (conveyance direction side). There is provided a separation mechanism 131 that separates the heater 32, which is a heating apparatus, from a sheet at the time of power failure or irregular stop. The separation mechanism 131 includes one or more heaters 32, a supply air blower 109, an exhaust 110, and an infrared conversion layer 114.

The separation mechanism 131 is connected to a lifting mechanism 134 via a wire 133. As illustrated in FIG. 8, the lifting mechanism 134 includes a spring 136. The spring 136 constantly applies upward tension to the separation mechanism 131 via the wire 133. The position of the separation mechanism 131 is fixed by a fixing mechanism 135. When an anomaly or a power failure occurs, the fixing mechanism 135 is released. Thus, an end of the separation mechanism 131 where the fixing mechanism 135 is located moves upward due to the tension from the lifting mechanism 134 (spring 136). As a result, the separation mechanism 131 rotates about a rotation shaft 132, and the heater 32 is separated from the sheet P on the conveying belt 35 facing the heater 32.

The fixing mechanism 135 includes, for example, an electromagnet or a latch mechanism. When an anomaly or a power failure occurs, a standby power source such as a battery is electrically connected to the fixing mechanism 135 to cause the fixing mechanism 135 to operate. Thus, the fixing of the separation mechanism 131 is released.

The heater 32 including the near-infrared lamp 111 and the infrared conversion layer 114 provides high output power, and the infrared conversion layer 114 is not easily cooled. Therefore, there is a risk that the sheet P may be continuously heated and burn-damaged by the stored heat even when conveyance of the sheet P is stopped to stop power supply to the heater 32 at the time of anomaly, such as a paper jam, or power failure. By providing the separation mechanism 131 to separate the heater 32 from the sheet P at the time of power failure or irregular stop, it is possible to prevent the sheet P on the conveying belt 35 facing the heater 32 from being continuously heated by the stored heat, and thus, burn-damage of the sheet P can be prevented.

The image forming apparatus 1 may include a second dryer 120 as a portion that assists in the drying of the sheet P to which liquid has adhered. The heater 32 of the dryer 30, which includes the near-infrared lamp 111 and the infrared conversion layer 114, provides high output power. Thus, there is a risk that when the sheet P is dried without stopping in the dryer 30, moisture in the sheet P may be excessively evaporated to cause deformation of the sheet P due to shrinkage of paper fibers. By providing the second dryer 120 as a second heater and gradually drying the sheet P by means of the dryer 30 and the second dryer 120, it is possible to prevent evaporation of moisture in the sheet P and to prevent deformation of the sheet P.

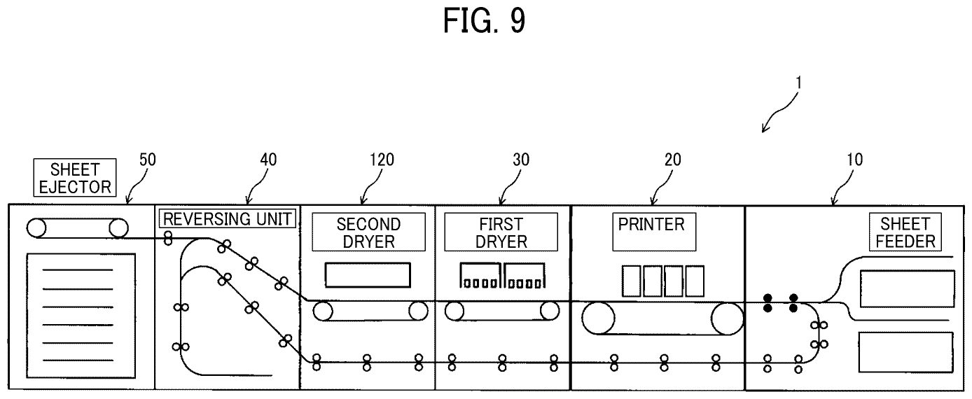

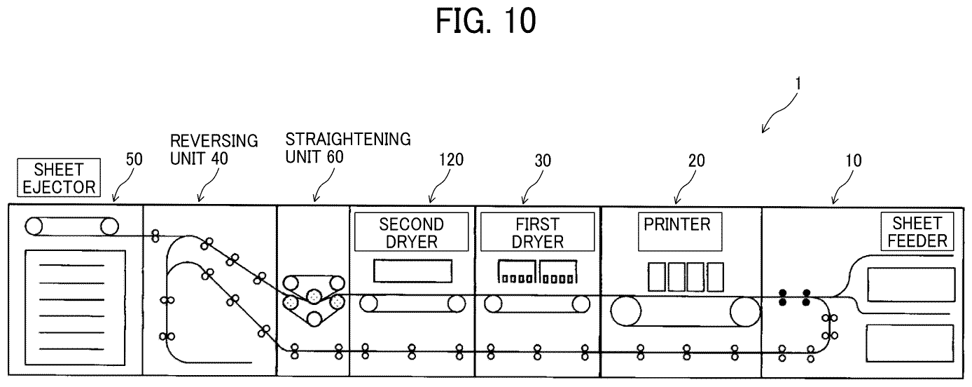

In the image forming apparatus illustrated in FIG. 1, the second dryer 120 is provided between the dryer 30 and the reversing unit 40 as illustrated in FIG. 9. In the image forming apparatus illustrated in FIG. 2, the second dryer 120 is provided between the dryer 30 and the straightening unit 60 as illustrated in FIG. 10.

The second dryer 120 has a function of heating the sheet P conveyed from the dryer 30, further drying liquid on the sheet P, and conveying the sheet P to the reversing unit 40 and the straightening unit 60.

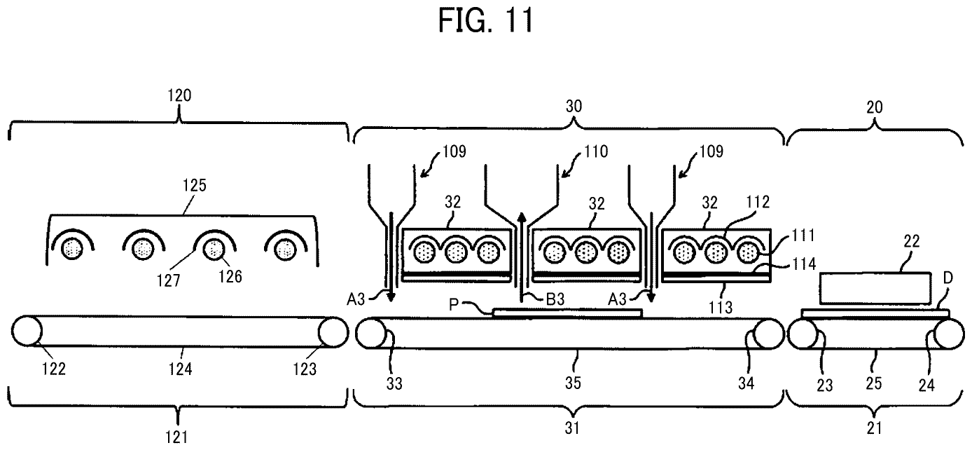

FIG. 11 is a schematic diagram illustrating an exemplary configuration of the dryer 30 and the second dryer 120. The second dryer 120 is provided downstream of the dryer 30 of FIG. 3. A sheet conveyor 121 of the second dryer 120 includes a driving roller 122, a driven roller 123, and a conveying belt 124. The driving roller 122 is a motor-driven roller. The driven roller 123 is driven to rotate. The conveying belt 124 is driven by these rollers.

The second dryer 120 includes irradiation lamps 126 as a light irradiation unit 125. The irradiation lamps emit, for example, infrared rays or ultraviolet rays. A reflecting plate 127 may also be provided. The light irradiation unit 125 heats the sheet P being moved by the sheet conveyor 121, and dries ink on the sheet P.

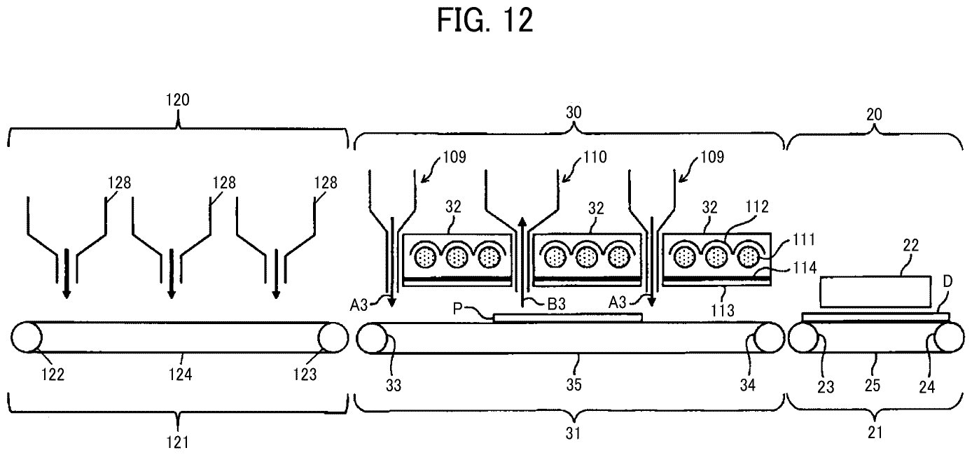

FIG. 12 is a schematic configuration diagram illustrating a second exemplary combination of the dryer 30 and the second dryer 120. Hot air units 128 are provided instead of the light irradiation unit 125 in the second dryer 120 of FIG. 11. The sheet P being moved by the sheet conveyor 121 is heated by the hot air units 128 to dry ink on the sheet P.

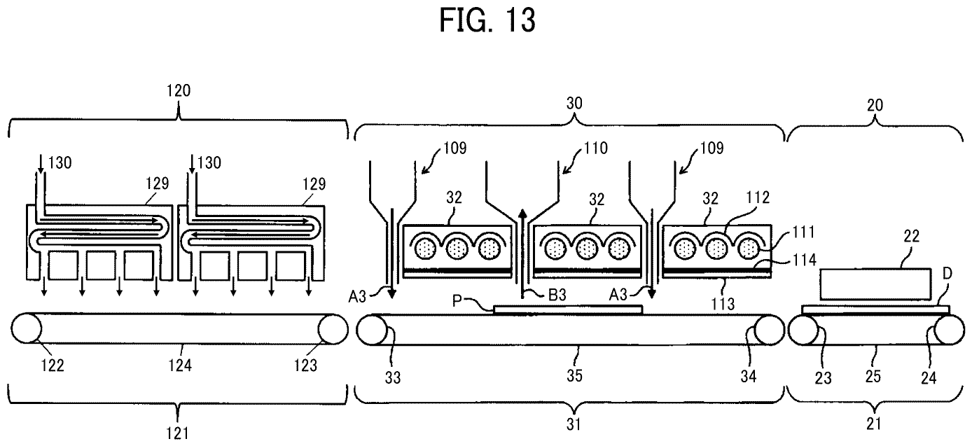

FIG. 13 is a schematic configuration diagram illustrating a third exemplary combination of the dryer 30 and the second dryer 120. Superheated steam injection units 129 are provided instead of the light irradiation unit 125 in the second dryer 120 of FIG. 10. Specifically, the superheated steam injection units 129 heat water supplied from feed-water inlets 130, inside the superheated steam injection units 129, and inject the water as superheated steam (steam exceeding 100° C.) . The superheated steam injection units 129 heat the sheet P being moved by the sheet conveyor 121, and dry ink on the sheet P.

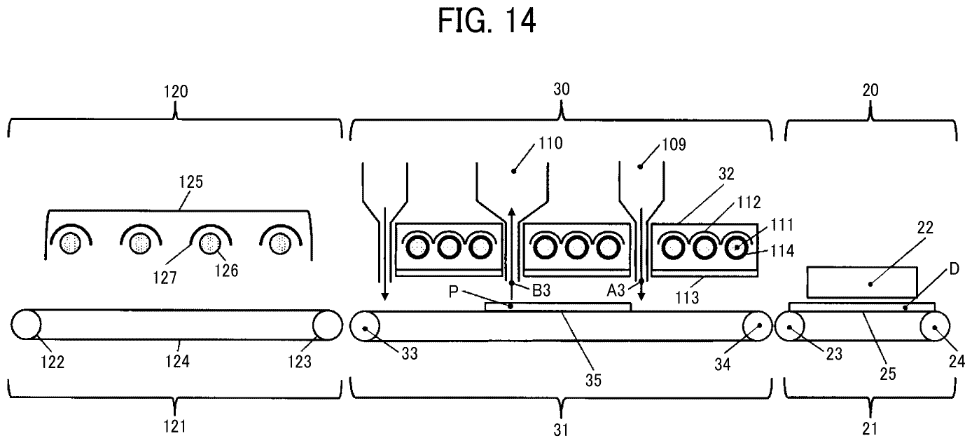

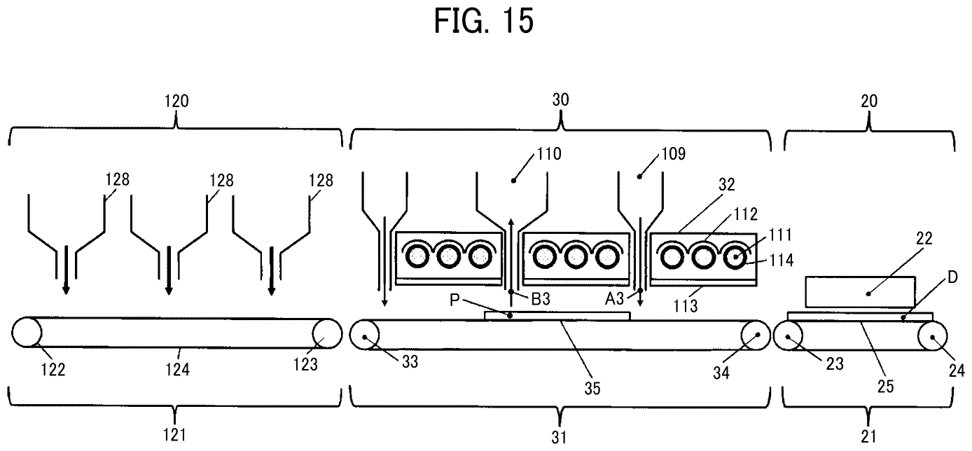

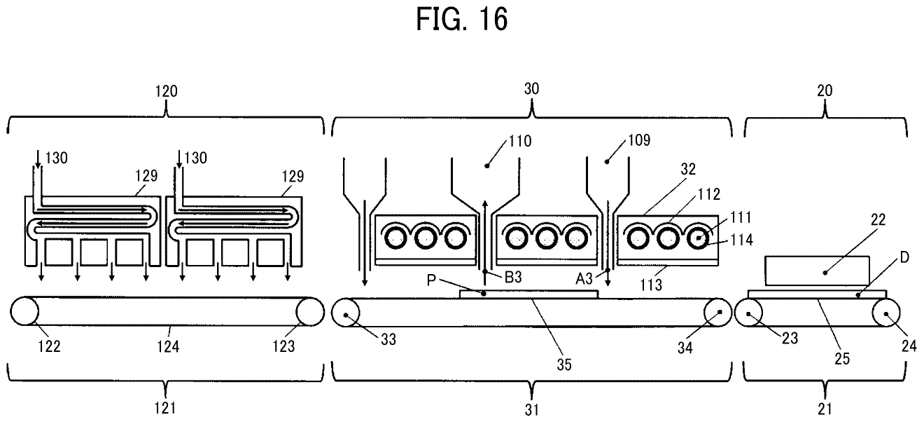

FIG. 14 is a schematic configuration diagram illustrating a fourth exemplary combination of the dryer 30 and the second dryer 120, in which the dryer 30 of FIG. 5 has been provided instead of the dryer 30 of FIG. 11. FIG. 15 is a schematic configuration diagram illustrating a fifth exemplary combination of the dryer 30 and the second dryer 120, in which the dryer 30 of FIG. 5 has been provided instead of the dryer 30 of FIG. 12. FIG. 16 is a schematic configuration diagram illustrating a sixth exemplary combination of the dryer 30 and the second dryer 120, in which the dryer 30 of FIG. 5 has been provided instead of the dryer 30 of FIG. 13.

The image forming apparatus 1 according to the above embodiment includes a recording head, near-infrared lamps, an air blower, and an exhaust. The recording head applies aqueous inks of two or more colors to a recording medium. The near-infrared lamps dry a printed material coated with ink, at a high speed. The air blower and an exhaust remove generated vapor. A single glass plate is provided between the multiple near-infrared lamps and the recording medium. An infrared absorption layer formed by application of an infrared absorption coating material (for example, black coating material) is installed on a surface of the glass plate facing the near-infrared lamps. This glass plate with the infrared absorption layer corresponds to a wavelength converter.

Near-infrared rays emitted from the near-infrared lamp are absorbed by the infrared absorption layer, and the infrared absorption layer generates heat to emit far-infrared rays (here, infrared rays having a wavelength of 2.5μm or more).

That is, near-infrared rays emitted from the multiple near-infrared lamps are converted into far-infrared rays by a single infrared absorption layer and emitted to the recording medium. The far-infrared rays are absorbed by a printed material to generate heat and dry ink. Unlike near-infrared rays, far-infrared rays reduce the difference in the amount of heat generation between ink colors. Thus, the difference in temperature between ink colors can be reduced. The same applies to the lamp of Japanese Patent No. 7275966. In the same publication, the term “visible light” refers to light with a wavelength of 0.4 μm or more and less than 0.7 μm, the term “near-infrared rays” refers to light with a wavelength of 0.7 μm or more and less than 2.5 μm, the term “mid-infrared rays” refers to light with a wavelength of 2.5 μm or more and less than 4.0 μm, and the term “far-infrared rays” refers to light with a wavelength of 4 μm or more.

A glass plate is provided which has a single infrared absorption layer provided for multiple infrared lamps. It is thus possible to reduce the cost and effort of part replacement for continuing emission of light in a desired peak wavelength range for the following reason. When coating is directly applied to a lamp as in the device described in Japanese Patent No. 7275966, it is necessary to replace the entire lamp when the coating peels off, leading to an increase in cost. In addition, it takes time and effort to replace multiple lamps when coating peels off.

Assume that unlike the present embodiment, a glass plate with an infrared absorption layer is provided away from a lamp. Even in such a case, it takes time and effort to determine a wavelength converter from which coating has peeled off and to replace only the wavelength converter when a single wavelength converter is provided separately for each lamp. The present embodiment has no such disadvantage. This is because a glass plate is provided which has a single infrared absorption layer provided for multiple infrared lamps.

Furthermore, by providing the single infrared absorption layer for the multiple infrared lamps, it is possible to reduce the difference in the temperature of ink between the infrared lamps, due to thermal diffusion of the infrared absorption layer.

In addition, the infrared absorption layer is disposed on a surface of the glass plate facing the near-infrared lamps, and the glass plate is interposed between a printed material and the near-infrared lamps. Therefore, contact between the printed material and a coating layer (infrared absorption layer) is prevented. It is thus possible to prevent the infrared absorption layer from being damaged or peeling off due to contact with the printed material.

The above-described embodiment is illustrative and does not limit the present disclosure. Thus, numerous additional modifications and variations are possible in light of the above teachings. For example, elements and/or features of different illustrative embodiments may be combined with each other and/or substituted for each other within the scope of the present disclosure.

For example, the above-described embodiment heats ink that is liquid discharged onto a sheet from the liquid discharger used for image formation in a print unit. Meanwhile, the above-described embodiment can also be applied to a drying device that dries treatment liquid applied for precoating in the above-described pretreatment unit, which may be disposed on the upstream side of the printer 20, on the upstream side of the printer 20.

Furthermore, the heating apparatus of the present disclosure can also be used for preheating to reduce moisture by heating a sheet surface where ink is to be received, on the upstream side of the printer 20 and to prevent curling due to moisture imbalance between the front and back sides of the sheet due to ink application in the printer 20.

Furthermore, although the image forming apparatus including the liquid discharger for image formation in the print unit has been described, the present disclosure can also be applied to an image forming apparatus that performs printing by means other than the liquid discharger. For example, the present disclosure can also be applied to the image forming apparatus described in Japanese Unexamined Patent Application Publication No. 2004-82389 in which a printer employs a plate cylinder printing method. In the image forming apparatus, water-based varnish is applied after image formation, and a drying device also dries the water-based varnish. The drying device of the present disclosure can also be used as the drying device of the image forming apparatus described in Japanese Unexamined Patent Application Publication No. 2004-82389.

In the present embodiment, the “printing apparatus” is described using an example of an inkjet recording apparatus. However, the “printing apparatus” is not limited to an apparatus that includes a liquid discharge head, which discharges liquid toward a surface to be dried of a sheet material, and visualizes significant images, such as letters and graphics, with the discharged liquid. For example, the “printing apparatus” may also be an apparatus that forms patterns and the like which have no meaning.

The sheet material is not limited to a specific material, and may be any material such as paper, thread, fiber, cloth, leather, metal, plastic, glass, wood, and ceramics as long as liquid can temporarily adhere thereto. For example, it is possible to use sheet materials to be used for film products, cloth products, such as clothing products, building materials, such as wallpaper or flooring materials, and leather products. The “printing apparatus” may include devices to feed, convey, and eject material to which liquid can adhere. The “printing apparatus” may further include a pretreatment device and a posttreatment device. The pretreatment device coats, with treatment liquid, the material onto which the liquid has been discharged. The posttreatment device coats, with treatment liquid, the material onto which the liquid has been discharged.

Furthermore, the term “liquid” includes any liquid having a viscosity or a surface tension that can be discharged from the head. However, preferably, the viscosity of the liquid is not greater than 30 mPa·s under ordinary temperature and ordinary pressure or by heating or cooling. More specifically, the liquid is a solution, a suspension, an emulsion, or the like containing a solvent such as water or an organic solvent, a colorant such as a dye or a pigment, a function-imparting material such as a polymerizable compound, a resin, or a surfactant, or the like. For example, these items can be used for inkjet ink, surface treatment liquid, or the like.

Furthermore, although the present disclosure has been applied to a light radiation apparatus as a heater of a drying device of a liquid discharge apparatus, the light radiation apparatus of the present disclosure can also be used for apparatuses other than the heating apparatus. In the embodiment, the peak wavelength range of light emitted from the near-infrared lamp, which has a spectral distribution with a peak wavelength around 1μm, is shifted to the long-wavelength side by the infrared wavelength converter to increase radiation intensity on the far-infrared side. Meanwhile, the present disclosure is not limited thereto. A light source that irradiates the wavelength converter with light and light to be emitted from the wavelength converter can be set according to intended uses of the light radiation apparatus.

A liquid discharge apparatus includes: a conveyor (31) to convey a medium in a conveyance direction; a liquid discharger (22) configured to discharge a liquid in a discharge direction orthogonal to the conveyance direction, onto a medium conveyed by the conveyor (31); and a heater (32) configured to heat the medium onto which the liquid has been applied, wherein the heater (32) includes: multiple near-infrared lamps (111) to irradiate the medium with near-infrared rays; and an infrared wavelength converter (114) to convert a wavelength of the near-infrared rays emitted from the multiple near-infrared lamps (111), and the infrared wavelength converter (114) is: disposed between the multiple near-infrared lamps (111) and the conveyor (31) in the discharge direction; and separated from the conveyor in the discharge direction.

The infrared wavelength converter (114) converts the near-infrared rays emitted from at least two or more of the multiple near-infrared lamps (111).

The infrared wavelength converter (114) includes: a substrate (113); and a conversion layer (114), the substrate (113) has: a first face facing the multiple near-infrared lamps (111); and a second face facing the conveyor (31), and the conversion layer (114) is on the first face of the substrate (113).

The heater (32) further includes a support (116) to support the infrared wavelength converter (114), and the infrared wavelength converter (114) is thermally insulated from the support (116).

The substrate (113) includes a glass plate (113), and the conversion layer (114) on the first face of the glass plate (113), and the glass plate (113) is separated from the multiple near-infrared lamps (111) and the conveyor in the discharge direction.

The infrared wavelength converter is on each surface of the multiple near-infrared lamps; and the substrate is: disposed between the multiple near-infrared lamps and the conveyor to transmit near-infrared rays emitted from the multiple near-infrared lamps in the discharge direction; and separated from the multiple near-infrared lamps (111) and the conveyor in the discharge direction.

The near-infrared lamp includes a reflector (112) configured to reflect near-infrared rays emitted from the multiple near-infrared lamps (111).

The liquid discharge apparatus further includes: an air blower (109) configured to blow air onto the medium; and an exhaust (110) configured to discharge vapor generated at the medium heated by the heater (32), wherein the infrared wavelength converter is disposed such that no air from the air blower (109) comes into contact with the multiple near-infrared lamps.

The heater (32) heats the medium onto which the liquid has been applied by the liquid discharger (22).

The liquid discharge apparatus further includes: an image former including the liquid discharger (22) to discharge the liquid onto the medium to form an image on the medium.

A light radiation apparatus includes: multiple lamps (111) to emit light; and a wavelength converter (113, 114) to convert a wavelength of the light emitted from each of the multiple lamps, wherein the wavelength converter (113, 114) is disposed: between the multiple lamps (111) and a medium to be heated; and separated from the multiple lamps (111), and the wavelength converter (113, 114) converts the wavelength of the light emitted from at least two or more of the lamps (111).

A light radiation apparatus includes: a lamp (111) to emit infrared ray; a wavelength converter (114) to convert a wavelength of the infrared ray emitted from the lamp; and a substrate disposed between the lamp (111) and a medium to be heated, wherein the wavelength converter (114) is on a surface of the lamp (111), and the substrate transmits the infrared ray emitted from the lamp to the medium.

A heating apparatus includes the light radiation apparatus (32).

An image forming apparatus includes: an image former (20) configured to form an image onto a medium; and the heating apparatus configured to heat the medium onto which the image has been formed.

The image forming apparatus further includes: a separator (131) configured to separate the heating apparatus from the medium on a conveyor in response to detection of a power failure or an irregular stop.

The image forming apparatus further includes: another heating apparatus (120) disposed downstream of the heating apparatus in a conveyance direction, said another heating apparatus configured to heat the medium heated by the heater, wherein said another heating apparatus (120) is disposed downstream of the heating apparatus (32) in the conveyance direction.

Said another heating apparatus (120) irradiates the medium with light to heat the medium. Said another heating apparatus (120) heats the medium with hot air. Said another heating apparatus (120) heats the medium with superheated steam.

The above description is exemplary, and the following aspects of the present disclosure have respective particular effects. In the description of the aspects, reference signs in parentheses after the names of elements are examples of corresponding members, and are not limited to the examples.

### Aspect 1

According to Aspect 1, a liquid discharge apparatus (1) includes: a liquid discharger (22) that discharges liquid to a liquid discharge target (P); and a heater (32) that heats the liquid discharge target (P), in which the heater (32) includes multiple near-infrared lamps (111) and an infrared wavelength converter (113, 114), and the infrared wavelength converter (113, 114) is disposed between the near-infrared lamps (111) and the liquid discharge target (P) in such a way as to be located away from the near-infrared lamps (111), the infrared wavelength converter (113, 114) being disposed such that one infrared wavelength converter (113, 114) is provided for at least two or more of the near-infrared lamps (111).

According to this aspect, it is possible to reduce the cost and effort of part replacement for continuing heating by emission of light in a desired peak wavelength range.

### Aspect 2

According to Aspect 2, in the liquid discharge apparatus (1) of Aspect 1, the infrared wavelength converter (113, 114) includes a substrate (113) and an infrared wavelength conversion layer (114), and the infrared wavelength conversion layer (114) is disposed on a surface facing the near-infrared lamps (111).

According to this aspect, it is possible to prevent contact with the liquid discharge target and reduce damage to the infrared wavelength conversion layer.

### Aspect 3

According to Aspect 3, in the liquid discharge apparatus (1) of Aspect 1 or 2, the infrared wavelength converter (113, 114) is substantially thermally insulated from a support (116, 117) supporting the near-infrared lamps (111).

According to this aspect, it is possible to prevent the support from conducting heat away from the infrared conversion layer that has generated heat by absorption of near-infrared rays and causing a change in the radiation wavelength and radiation intensity of far-infrared rays.

### Aspect 4

According to Aspect 4, a liquid discharge apparatus (1) includes: a liquid discharger (22) that discharges liquid to a liquid discharge target (P); and a heater (32) that heats the liquid discharge target (P), in which the heater (32) includes: a near-infrared lamp (111); an infrared wavelength converter (114) provided on a surface of the near-infrared lamp (111); and a substrate (13) that transmits infrared rays, the substrate (13) being located between the near-infrared lamp (111) and the liquid discharge target (P).

According to this aspect, it is possible to prevent contact with the liquid discharge target, to reduce damage to the infrared wavelength conversion layer, and to reduce the cost and effort of part replacement for continuing heating by emission of light in a desired peak wavelength range.

### Aspect 5

According to Aspect 5, in the liquid discharge apparatus (1) of any one of Aspects 1 to 4, the near-infrared lamp (111) includes a reflector (112, 115) that reflects near-infrared rays.

According to this aspect, by reflecting near-infrared rays from a surface of the near-infrared lamp not facing the infrared wavelength converter, it is possible to efficiently irradiate the infrared wavelength converter with near-infrared rays emitted from the near-infrared lamp.

### Aspect 6

According to Aspect 6, the liquid discharge apparatus (1) of any one of Aspects 1 to 5 further includes: an air blower (109) that blows air onto the liquid discharge target (P); and an exhaust (110) that discharges vapor generated at the liquid discharge target (P) heated by the heater (32). The infrared wavelength converter (113, 114) is disposed such that no air from the air blower (109) comes into contact with the near-infrared lamp (111).

According to this aspect, the vapor discharger including the air blower and the exhaust reduces the humidity and saturated vapor pressure of a drying furnace due to evaporation of solvent in liquid such as ink, and improves drying property of the liquid.

In addition, it is possible to prevent the near-infrared lamp from coming into contact with an airflow generated by the vapor discharger and decreasing in temperature to cause a change in the wavelength and irradiation intensity of near-infrared rays to be emitted.

### Aspect 7

According to Aspect 7, in the liquid discharge apparatus (1) of any one of Aspects 1 to 6, the heater (32) heats the liquid discharge target (P) to which liquid from the liquid discharger (22) has adhered.

According to this aspect, it is possible to heat the liquid discharge target (P) to which liquid from the liquid discharger (22) has adhered and evaporate the liquid.

### Aspect 8

According to Aspect 8, in the liquid discharge apparatus (1) of any one of Aspects 1 to 6, the liquid discharger (22) is an image former that discharges liquid to the liquid discharge target (P) to form an image.

According to this aspect, it is possible to heat the liquid discharge target (P) to which image forming liquid from the liquid discharger (22) has adhered and evaporate moisture in the image forming liquid.

### Aspect 9

According to Aspect 9, a light radiation apparatus (32) includes multiple lamps (111) and a wavelength converter (113, 114), in which the wavelength converter (113, 114) is disposed between the lamps (111) and an object (P) to be heated in such a way as to be located away from the lamps (111). The wavelength converter (113, 114) is provided for at least two or more of the lamps (111).

According to this aspect, it is possible to reduce the cost and effort of part replacement for continuing emission of light in a desired peak wavelength range.

### Aspect 10

According to Aspect 10, a light radiation apparatus includes a lamp (111) and a wavelength converter (114), in which the wavelength converter (114) is disposed on a surface of the lamp (111), and a substrate (113) that allows transmission of infrared rays is disposed between the lamp (111) and an object (P) to be heated.

According to this aspect, it is possible to reduce the cost and effort of part replacement for continuing emission of light in a desired peak wavelength range.

### Aspect 11

According to Aspect 11, a heating apparatus including the light radiation apparatus (32) of Aspect 9 or 10 makes it possible to reduce the cost and effort of part replacement for continuing heating by emission of light in a desired peak wavelength range.

### Aspect 12

According to Aspect 12, an image forming apparatus (1) includes: an image former (20) that forms an image on a recording medium (P); and a heater (32) that heats the recording medium (P), in which the heating apparatus of Aspect 11 is used as the heater (32).

According to this aspect, it is possible to reduce the cost and effort of part replacement for continuing heating of the recording medium (P) by emission of light in a desired peak wavelength range.

### Aspect 13

According to Aspect 13, the image forming apparatus (1) of Aspect 12 further includes a mechanism (131) that separates the heating apparatus (32) from the recording medium (P) during a power failure or an irregular stop.

According to this aspect, burn-damage to the recording medium can be prevented.

### Aspect 14

According to Aspect 14, the image forming apparatus (1) of Aspect 12 or 13 further includes a second heater (120) that heats the recording medium, the second heater (120) being located on a downstream side of the heater (32) in a conveyance direction of the recording medium.

According to this aspect, it is possible to prevent evaporation of moisture in the recording medium (P) to prevent deformation of the recording medium (P).

### Aspect 15

According to Aspect 15, in the image forming apparatus (1) of Aspect 14, the second heater (120) heats the recording medium (P) by light irradiation.

According to this aspect, it is possible to prevent evaporation of moisture in the recording medium (P) to prevent deformation of the recording medium (P).

### Aspect 16

According to Aspect 16, in the image forming apparatus (1) of Aspect 14, the second heater (120) heats the recording medium (P) with hot air.

According to this aspect, it is possible to prevent evaporation of moisture in the recording medium (P) to prevent deformation of the recording medium (P).

### Aspect 17

According to Aspect 17, in the image forming apparatus (1) of Aspect 14, the second heater (120) heats the recording medium (P) with superheated steam.

According to this aspect, it is possible to prevent evaporation of moisture in the recording medium (P) to prevent deformation of the recording medium (P).

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

1. A liquid discharge apparatus comprising:
a conveyor to convey a medium in a conveyance direction;
a liquid discharger configured to discharge a liquid in a discharge direction orthogonal to the conveyance direction, onto a medium conveyed by the conveyor; and
a heater configured to heat the medium onto which the liquid has been applied,
wherein the heater includes:
multiple near-infrared lamps to irradiate the medium with near-infrared rays; and
an infrared wavelength converter to convert a wavelength of the near-infrared rays emitted from the multiple near-infrared lamps, and
the infrared wavelength converter is:
disposed between the multiple near-infrared lamps and the conveyor in the discharge direction; and
separated from the conveyor in the discharge direction.

2. The liquid discharge apparatus according to claim 1,
wherein the infrared wavelength converter converts the near-infrared rays emitted from at least two or more of the multiple near-infrared lamps.

3. The liquid discharge apparatus according to claim 1,
wherein the infrared wavelength converter includes:
a substrate; and
a conversion layer,
the substrate has:
a first face facing the multiple near-infrared lamps; and
a second face facing the conveyor, and
the conversion layer is on the first face of the substrate.

4. The liquid discharge apparatus according to claim 1,
wherein the heater further includes a support to support the infrared wavelength converter, and
the infrared wavelength converter is thermally insulated from the support.

5. The liquid discharge apparatus according to claim 3,
wherein the substrate includes a glass plate, and
the conversion layer in on the first face of the glass plate, and
the glass plate is separated from the multiple near-infrared lamps and the conveyor in the discharge direction.

6. The liquid discharge apparatus according to claim 3,
wherein the infrared wavelength converter is on each surface of the multiple near-infrared lamps; and
the substrate is:
disposed between the multiple near-infrared lamps and the conveyor to transmit near-infrared rays emitted from the multiple near-infrared lamps in the discharge direction; and
separated from the multiple near-infrared lamps and the conveyor in the discharge direction.

7. The liquid discharge apparatus according to claim 1,
wherein the multiple near-infrared lamps include a reflector configured to reflect near-infrared rays emitted from the multiple near-infrared lamps.

8. The liquid discharge apparatus according to claim 1, further comprising:
an air blower configured to blow air onto the medium; and
an exhaust configured to discharge vapor generated at the medium heated by the heater,
wherein the infrared wavelength converter is disposed such that no air from the air blower comes into contact with the multiple near-infrared lamps.

9. The liquid discharge apparatus according to claim 1,
wherein the heater heats the medium onto which the liquid has been applied by the liquid discharger.

10. The liquid discharge apparatus according to claim 1, further comprising:
an image former including the liquid discharger to discharge the liquid onto the medium to form an image on the medium.

11. A light radiation apparatus comprising:
multiple lamps to emit light; and
a wavelength converter to convert a wavelength of the light emitted from each of the multiple lamps,
wherein the wavelength converter is disposed:
between the multiple lamps and a medium to be heated; and
separated from the multiple lamps, and
the wavelength converter converts the wavelength of the light emitted from at least two or more of the lamps.

12. A light radiation apparatus comprising:
a lamp to emit infrared ray;
a wavelength converter to convert a wavelength of the infrared ray emitted from the lamp; and
a substrate disposed between the lamp and a medium to be heated,
wherein the wavelength converter is on a surface of the lamp, and
the substrate transmits the infrared ra emitted from the lamp to the medium.

13. A heating apparatus comprising the light radiation apparatus according to claim 12.

14. An image forming apparatus comprising:
an image former configured to form an image onto a medium; and
the heating apparatus according to claim 13 configured to heat the medium onto which the image has been formed.

15. The image forming apparatus according to claim 14, further comprising:
a separator configured to separate the heating apparatus from the medium on a conveyor in response to detection of a power failure or an irregular stop.

16. The image forming apparatus according to claim 14, further comprising:
another heating apparatus disposed downstream of the heating apparatus in a conveyance direction, said another heating apparatus configured to heat the medium heated by the heating apparatus,
wherein said another heating apparatus is disposed downstream of the heating apparatus in the conveyance direction.

17. The image forming apparatus according to claim 16,
wherein said another heating apparatus irradiates the medium with light to heat the medium.

18. The image forming apparatus according to claim 16,
wherein said another heating apparatus heats the medium with hot air.

19. The image forming apparatus according to claim 16,
wherein said another heating apparatus heats the medium with superheated steam.
